(19) United States
(12) Patent Application Publication
(10) Pub. No.: US 2012/0054997 A1
(43) Pub. Date: Mar. 8, 2012

(54) PROCESS AND SYSTEM FOR DISASSEMBLING FUEL INJECTOR

(75) Inventors: Daryl Villa, Ridgeway, SC (US); Michael Castelluccio, Columbia, SC (US); Joshua Kyle Dalrymple, Columbia, SC (US); Philip Vince, Columbia, SC (US)

(73) Assignee: International Engine Intellectual Property Company, Warrenville, IL (US)

(21) Appl. No.: 13/041,514

(22) Filed: Mar. 7, 2011

Related U.S. Application Data
(60) Provisional application No. 61/312,197, filed on Mar. 9, 2010.

(51) Int. Cl. B23P 19/00; B23P 11/00

(52) U.S. Cl. 29/426.1; 29/791

(57) ABSTRACT

An system for disassembling a fuel injector includes the first station for removing an end-cap assembly, an external O-ring and a control valve body (CVB) spool from the fuel injector, the second station for receiving the fuel injector from the first station and removing a snap ring, a ferrule ring, a cone-nut and screws from the fuel injector, and the third station for receiving the fuel injector from the second station and removing a plunger, a clevis, a piston, an intensifier O-ring, a gasket and a high pressure group from the fuel injector.

### CROSS REFERENCE TO PRIOR APPLICATIONS

This application claims the benefit from U.S. Provisional Application No. 61/312,197 filed on Mar. 9, 2010, which is hereby incorporated by reference for all purposes as if fully set forth herein.

### BACKGROUND OF THE DISCLOSURE

1. Field of the Disclosure

This disclosure relates to a process for disassembling fuel injectors, and more particularly to a process and system for disassembling fuel injectors.

2. Related Art

Prior to remanufacturing, a used fuel injector must undergo a disassembly/tear-down process. Disassembling a fuel injector can be a complicated, labor-intensive and time-consuming process. Generally, a fuel injector is an assembly of numerous components of various sizes and configurations that are put together using various engagement mechanisms. Thus, without a well-planned process flow, the entire disassembly process may be easily delayed or stopped frequently, thereby increasing remanufacturing costs. Accordingly, there is a need for an efficient fuel injector disassembly methodology.

### SUMMARY OF THE DISCLOSURE

According to an aspect of the disclosure, an system for disassembling a fuel injector includes a first station for removing an end-cap assembly, an external O-ring and a control valve body (CVB) spool from the fuel injector, a second station for receiving the fuel injector from the first station and removing a snap ring, a ferrule ring, a cone-nut and M4 screws from the fuel injector, and a third station for receiving the fuel injector from the second station and removing a plunger, a clevis, a piston, an intensifier O-ring, a copper gasket and a high pressure group from the fuel injector.

The system may further include a transport unit for moving the fuel injector from the first station to the second station and from the second station and the third station. The transport unit may be a conveyor. The conveyor may transport a tote carrying a plurality of fuel injectors.

The first station may include a tool for breaking a thru-rod of the fuel injector to remove the end-cap assembly therefrom, a tool for cutting the external O-ring, and a tool for removing the CVB spool from the fuel injector. The tool for removing the CVB spool may include a pinned fixture.

The second station may include a tool for removing the snap ring and the ferrule ring from the fuel injector, a tool for untorquing the cone-nut from an intensifier body of the fuel injector, and a tool for removing the M4 screws from the fuel injector. The tool for removing the snap ring and the ferrule ring may include a punching tool. The tool for untorquing the cone-nut may include a torque gun. The tool for removing the M4 screws may include a fixtured nut runner.

The third station may include a tool for exposing the plunger, the clevis and the piston of the fuel injector, a tool for removing the intensifier O-ring from the fuel injector, a tool for removing the copper gasket from the fuel injector, and a tool for exposing a high pressure group of the fuel injector. The tool for removing the intensifier O-ring may include a punching tool. The tool for removing the copper gasket may include a tool for applying a downward pressure on a nozzle of the fuel injector against an elastomeric material.

According to another aspect of the disclosure, a method of disassembling a fuel injector includes removing an end-cap assembly, an external O-ring and a control value body (CVB) spool from the fuel injector at a first station, moving the fuel injector from the first station to a second station, removing a snap ring, a ferrule ring, a cone-nut and M4 screws from the fuel injector at the second station, moving the fuel injector from the second station to a third station, and removing a plunger, a clevis, a piston, an intensifier O-ring, a copper gasket and a high pressure group from the fuel injector at the third station.

The method may further include placing a plurality of fuel injectors in a tote and moving the tote from the first station to the second station and from the second station to the third station. The moving the tote may include transporting the tote using a conveyor. The method may further include sorting the end-cap assembly, the external O-ring, the control value body (CVB) spool, the snap ring, the ferrule ring, the cone-nut, the M4 screws, the plunger, the clevis, the piston, the intensifier O-ring and the copper gasket disassembled from the fuel injector.

The end-cap assembly may be removed by cutting a thru-rod of the fuel injector, the external O-ring may be removed by punching and the CVB spool may be removed by using a pinned fixture. The snap ring and the ferrule ring may be removed by punching, the cone-nut may be removed by untorquing the cone-nut and the M4 screws may be removed by using a fixtured nut runner. The intensifier O-ring may be removed by punching and the copper gasket may be removed by applying a downward pressure to a nozzle of the fuel injector against an elastomeric material. The high pressure group may be manually removed after placing the fuel injector to a fixture to expose the high pressure group.

Additional features, advantages, and embodiments of the disclosure may be set forth or apparent from consideration of the following detailed description, drawings, and claims. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 shows an example of a fuel injector that may be disassembled using the system or process of the disclosure

FIG. 2 shows a system for disassembling the fuel injector of FIG. 1, constructed according to the principles of the disclosure; and

FIG. 3 shows a process for disassembling the fuel injector of FIG. 1 using the system shown in FIG. 2, according to the principles of the disclosure.

### DETAILED DESCRIPTION OF THE DISCLOSURE

The embodiments of the disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure, which is defined solely by the appended claims and applicable law. Moreover, it is noted that like reference numerals represent similar parts throughout the several views of the drawings.

A “computer”, as used in this disclosure, means any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a super computer, a personal computer, a laptop computer, a palmtop computer, a notebook computer, a desktop computer, a workstation computer, a server, or the like, or an array of processors, microprocessors, central processing units, general purpose computers, super computers, personal computers, laptop computers, palmtop computers, notebook computers, desktop computers, workstation computers, servers, or the like. Further, the computer may include an electronic device configured to communicate over a communication link. The electronic device may include, for example, but is not limited to, a mobile telephone, a personal data assistant (PDA), a mobile computer, a stationary computer, a smart phone, mobile station, user equipment, or the like.

The terms “including”, “comprising” and variations thereof, as used in this disclosure, mean “including, but not limited to”, unless expressly specified otherwise.

The terms “a”, “an”, and “the”, as used in this disclosure, means “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

A “computer-readable medium”, as used in this disclosure, means any medium that participates in providing data (for example, instructions) which may be read by a computer. Such a medium may take many forms, including non-volatile media, volatile media, and transmission media. Non-volatile media may include, for example, optical or magnetic disks and other persistent memory. Volatile media may include dynamic random access memory (DRAM). Transmission media may include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a computer. For example, sequences of instruction (i) may be delivered from a RAM to a processor, (ii) may be carried over a wireless transmission medium, and/or (iii) may be formatted according to numerous formats, standards or protocols, including, for example, WiFi, WiMAX, IEEE 802.11, DECT, 0G, 1G, 2G, 3G or 4G cellular standards, Bluetooth, or the like.

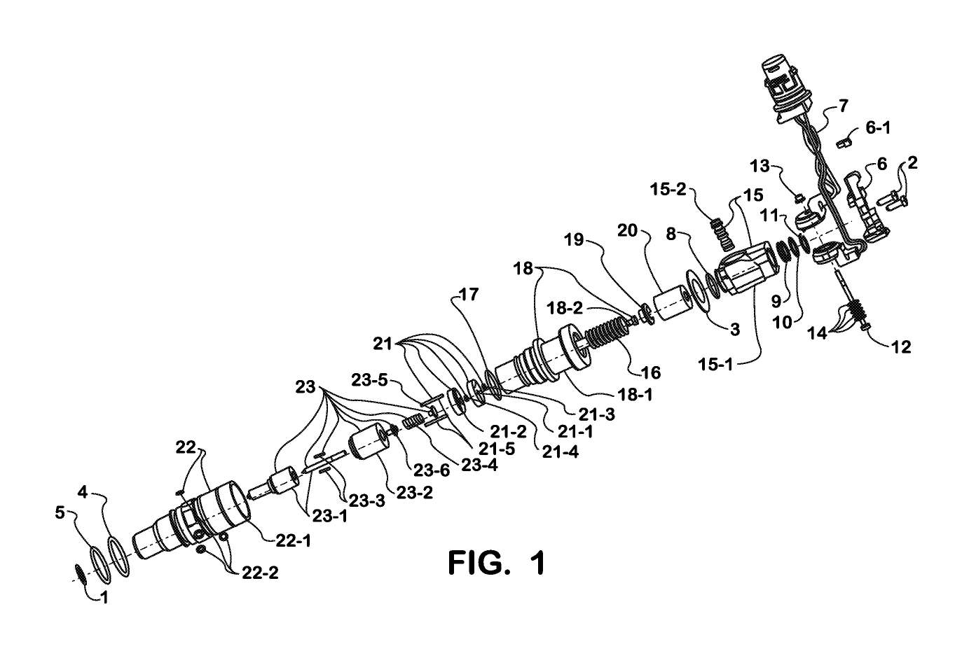

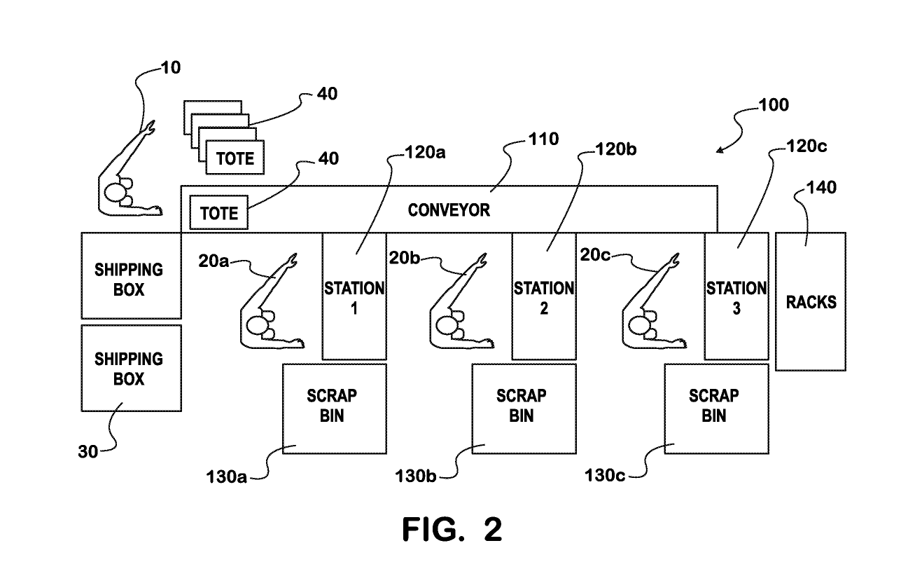

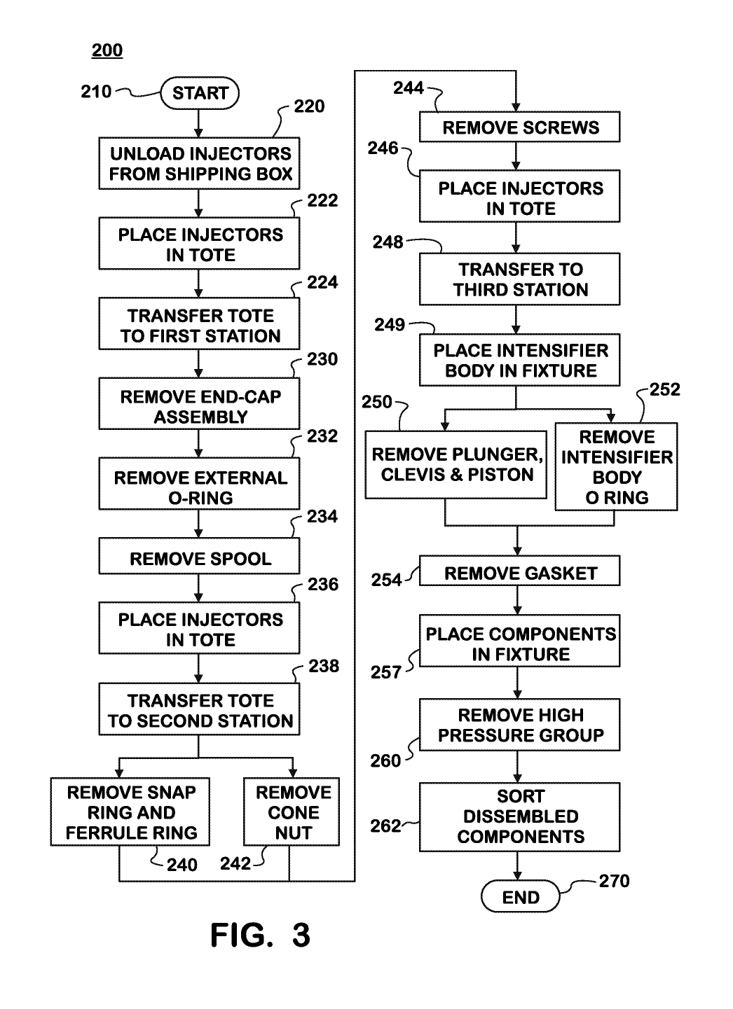

FIG. 1 shows an example of a fuel injector that may be disassembled using the system 100 (shown in FIG. 2) and/or the process 200 (shown in FIG. 3). The fuel injector may comprise a gasket 1, a screw (e.g., M4 screw) 2, a shim 3, an O-ring cone nut (upper) 4, an O-ring cone nut (lower) 5, a wire guide 6, an end cap assembly 7, an O-ring (control valve body) 8, an O-ring 9, a ferrule ring 11, a screw (e.g., M2 screw) 12, a nut 13, washer 14, a control valve assembly 15, a spring 16, an O-ring intensifier 17, an intensifier assembly 18, a clevis 19, a piston 20, a disk check assembly 21, a nut assembly 22, a nozzle nut assembly 23. The wire guide 6 may include a wire tie 6-1. The control valve assembly 15 may include a control valve body (CVB) 15-1 and a spool 15-2. The intensifier assembly 18 may include an intensifier body 18-1 and a plunger 18-2. The disk check assembly 21 may include an upper disk 21-1, a lower disk 21-2, a ball 21-3, a check plate 21-4, and a dowel pin 21-5. The nut assembly 22 may include a nut 22-1 and a filter 22-2. The nozzle unit assembly 23 may include a nozzle 23-1, a spring cage 23-2, a dowel pin 23-3, a nozzle spring 23-4, an upper spring guide 23-5, and a spring seat pin 23-6.

FIG. 2 shows a system 100 for disassembling used fuel injectors such as, for example, the fuel injector shown in FIG. 1, which may be collected for remanufacturing. The system 100 may include a conveyor 110, a first station 120a, a second station 120b and a third station 120c (hereafter concurrently referred to as stations 120). The conveyor 110 may be configured to transport fuel injectors (not shown) between the stations 120. The fuel injectors may be grouped together and transported in a tote 40. For example, the fuel injectors may be delivered in shipping boxes 30 to a disassembly facility that includes the system 100. An operator 10 may unload the fuel injectors from the shipping boxes 30 and place fuel injectors in totes 40. Each tote 40 may store a predetermined number of fuel injectors, e.g., twenty four fuel injectors per tote.

Referring to FIGS. 1 and 2, the tote 40 may be first transported via the conveyor 110 to the first station 120a. The first station 120a may be operated by a first operator 20a. The first operator 20a may unload the fuel injectors from the tote 40 to the first station 120a. The first station 120a may include various disassembly tools, such as, e.g., a breaking tool (not shown), a punching tool (not shown) and a pinned fixture (not shown). The first operator 20a may break a thru-rod (e.g., the screw 12, shown in FIG. 1) of the fuel injector using the breaking tool in order to remove the end-cap assembly 7 from the fuel injector. The first operator 20a may cut the external O-ring 4, 5 of the fuel injector using the punching tool. Further, the first operator 20a may remove the control valve body (CVB) spool 15-2 from the fuel injector using the pinned fixture. The components removed from the fuel injectors at the first station 120a may be placed in a first scrap bin 130a, which may be located adjacent to, or in the first station 120a. The partially disassembled fuel injectors may be placed in the tote 40 and transported to the second station 120b via the conveyor 110.

Upon arriving at the second station 120b in the tote 40, the partially disassembled fuel injectors may be removed from the tote 40 by a second operator 20b. The second station 120b may include various disassembly tools, such as, e.g., a supporting fixture (not shown), a punching tool (not shown), a torque gun (not shown) and a fixtured nut runner (not shown). The second operator 20b may place a fuel injector into the supporting fixture and use the punching tool to remove a snap ring 11 and a ferrule ring 10 from the CVB 15-1 of the fuel injector. The second operator 20b may use the torque gun to untorque a cone nut from the intensifier body 18-1 of the fuel injector. The fixtured nut runners may be used to remove, e.g., the M4 screws 2 that secure the CVB 15-1 to the fuel injector. The components removed from the fuel injectors at the second station 120a may be placed in a second scrap bin 130b, which may be located adjacent to, or in the second station 120a. The partially disassembled fuel injectors may be placed in the tote 40 and transported to the third station 120c via the conveyor 110.

The third station 120c may be operated by a third operator 20c. The third operator 20c may unload the partially disassembled fuel injectors from the tote 40 to the third station 120c. The third station 120c may include a number of disassembly tools, such as, for example, fixtures (not shown), a punching tool (not shown) and a pressurizer (not shown). The third operator 20c may put the intensifier body assembly 18 of the fuel injector in the fixture to expose the plunger 18-2, the clevis 19 and the piston 20 of the fuel injector. The third operator 20c may manually remove the exposed plunger 18-2, clevis 19 and piston 20 from the fuel injector, which may be placed in a third scrap bin 130c located adjacent to, or in the third station 120c. The third operator 20c may use the punching tool to cut and remove the intensifier O-ring from the fuel injector. Further, the third operator 20c may use, e.g., the pressurizer, to apply a downward pressure to the nozzle of the fuel injector against an elastomeric material (not shown) to remove a copper gasket 1 therefrom. Then, the third operator 20c may place the removed components into the fixture to expose and manually remove a high pressure group (not shown) from the fuel injector.

The disassembled components collected in the first, second and third scrap bins 130a, 130b, 130c may be then sorted and stored in appropriate bins (not shown) in racks 140 for disposal and/or recycling, and the tote 40 may be returned to the operator 10 to carry another group of fuel injectors unloaded from the shipping boxes 30.

FIG. 3 shows a process 200 for disassembling fuel injectors using the system 100 shown in FIG. 2, according to the principles of the disclosure. Upon starting the process 200 (at 210), fuel injectors may be unloaded from the shipping box 30 (at step 220) and placed in the totes 40 (at 222). Each tote 40 containing a predetermined number of fuel injectors may be transferred to the first station 120a via the conveyor 110 (at 224). At the first station 120a, the thru-ring of the fuel injector may be cut or broken to remove the end-cap assembly from the fuel injector (at 230). The external O-ring may be cut by, e.g., punching, and removed from the fuel injector (at 232). The CVB spool may be removed from the fuel injector by using, e.g., the pinned fixture (not shown) (at 234). The components that have been disassembled from the fuel injector may be placed in the first scrap bin 130a. The partially disassembled fuel injectors may be placed in the totes 40 (at 236) and transferred to the second station 120b via the conveyor 110 (at 238).

The fuel injectors in the tote 40 transferred from the first station 120a may be unloaded to the second station 120b for further disassembly (at 238). For example, the snap ring and the ferrule ring may be removed from the fuel injector (at 240) by, e.g., punching. At substantially the same time (or at a different time), the cone nut may be removed from the fuel injector (at 242) by, e.g., untorquing using the torquing gun. Further, the screws (e.g., M4 screws) may be removed from the fuel injector (at 244) by using, e.g., the fixtured nut runner (not shown). The components that have been disassembled from the fuel injector at station 120b may be placed in the second scrap bin 130b, and the fuel injectors disassembled at the second station 120b may be placed in the tote 40 (at 246) and transferred to the third station 120c (at 248).

Upon arriving the third station 120c, the fuel injectors may be unloaded to the third station 120c for further disassembly (at 248). For example, the intensifier body assembly of the fuel injector may be put in the fixture (not shown) to expose and remove the plunger, the clevis and the position from the fuel injector (at 250). At substantially the same time (or at a different time), the intensifier body O-ring may be cut and removed from the fuel injector (at 252) by, e.g., punching. Then, the copper gasket may be removed from the fuel injector (at 254) by, e.g., applying a downward pressure on the nozzle of the fuel injector against the elastomeric material. Further, the fuel injector may be placed into the fixture to expose and remove the high pressure group from the fuel injector (at 260). The disassembled components may be placed in the third scrap bin 130c, and the empty tote 40 may be returned to carry another group of fuel injectors for disassembly. The disassembled components in the first, second and third scrap bins 130a, 130b, 130c may be sorted and stored in appropriated bins in the racks 140 (at 262) and the process 200 may terminate (at 270).

Accordingly, the fuel injector tear-down process may be completed more efficiently and in a shorter period of time. Since the sub-processes of the disassembly process 200 are specialized at a plurality of stations 120a-120c, the sub-processes may be carried out with great efficiency and quality.

According to an aspect of the disclosure, the process 200 may be automated and carried out under the control of a computer (not shown), which may be included in the system 100. One or more of the operators 10, 20a, 20b, 20c may be replaced by, for example, a robot that operates under the control of the computer. A computer readable medium may be provided that includes a computer program tangibly embodied therein. The computer program may include a section (or segment) of code that, when executed on the computer, may cause some or all of the Steps 210 to 270 of FIG. 3 to be carried out.

While the disclosure has been described in terms of exemplary embodiments, those skilled in the art will recognize that the disclosure can be practiced with modifications in the spirit and scope of the appended claims. These examples given above are merely illustrative and are not meant to be an exhaustive list of all possible designs, embodiments, applications or modifications of the disclosure.

What is claimed is:

1. A system for disassembling a fuel injector comprising:
a first station for removing an end-cap assembly, an external O-ring and a control valve body (CVB) spool from the fuel injector;
a second station for receiving the fuel injector from the first station and removing a snap ring, a ferrule ring, a cone-nut and screws from the fuel injector; and
a third station for receiving the fuel injector from the second station and removing a plunger, a clevis, a piston, an intensifier O-ring, a copper gasket and a high pressure group from the fuel injector.

2. The system of claim 1, further comprising a transport unit for moving the fuel injector from the first station to the second station and from the second station to the third station.

3. The system of claim 2, wherein the transport unit comprises a conveyor.

4. The system of claim 3, wherein the conveyor transports a tote carrying a plurality of fuel injectors.

5. The system of claim 1, wherein the first station comprises:
a tool for breaking a thru-rod of the fuel injector to remove the end-cap assembly therefrom;
a tool for cutting the external O-ring; and
a tool for removing the CVB spool from the fuel injector.

6. The system of claim 5, wherein the tool for removing the CVB spool comprises a pinned fixture.

7. The system of claim 1, wherein the second station comprises:
a tool for removing the snap ring and the ferrule ring from the fuel injector;
a tool for untorquing the cone-nut from an intensifier body of the fuel injector; and
a tool for removing the screws from the fuel injector.

8. The system of claim 7, wherein the tool for removing the snap ring and the ferrule ring comprises a punching tool.

9. The system of claim 7, wherein the tool for untorquing the cone-nut comprises a torque gun.

10. The system of claim 7, wherein the tool for removing the screws comprises a fixtured nut runner.

11. The system of claim 1, wherein the third station comprises:
a tool for exposing the plunger, the clevis and the piston of the fuel injector;
a tool for removing the intensifier O-ring from the fuel injector;
a tool for removing the copper gasket from the fuel injector; and
a tool for exposing a high pressure group of the fuel injector.

12. The system of claim 11, wherein the tool for removing the intensifier O-ring comprises a punching tool.

13. The system of claim 11, wherein the tool for removing the copper gasket comprises a tool for applying a downward pressure on a nozzle of the fuel injector against an elastomeric material.

14. A method of disassembling a fuel injector comprising:
removing an end-cap assembly, an external O-ring and a control value body (CVB) spool from the fuel injector at a first station;
moving the fuel injector from the first station to a second station;
removing a snap ring, a ferrule ring, a cone-nut and M4 screws from the fuel injector at the second station;
moving the fuel injector from the second station to a third station; and
removing a plunger, a clevis, a piston, an intensifier O-ring, a gasket and a high pressure group from the fuel injector at the third station.

15. The method of claim 14, further comprising:
placing a plurality of fuel injectors in a tote; and
moving the tote from the first station to the second station and from the second station to the third station.

16. The method of claim 15, wherein the moving the tote comprises transporting the tote using a conveyor.

17. The method of claim 14, further comprising sorting at least one of the end-cap assembly, the external O-ring, the control value body (CVB) spool, the snap ring, the ferrule ring, the cone-nut, the screws, the plunger, the clevis, the piston, the intensifier O-ring and the gasket disassembled from the fuel injector.

18. The method of claim 14, wherein the end-cap assembly is removed by cutting a thru-rod of the fuel injector, the external O-ring is removed by punching and the CVB spool is removed by using a pinned fixture.

19. The method of claim 14, wherein the snap ring and the ferrule ring are removed by punching, the cone-nut is removed by untorquing the cone-nut and the screws are removed by using a fixtured nut runner.

20. The method of claim 14, wherein the intensifier O-ring is removed by punching, the gasket is removed by applying a downward pressure to a nozzle of the fuel injector against an elastomeric material, and the high pressure group is manually removed after placing the fuel injector to a fixture to expose the high pressure group.
